(19) United States
(12) Patent Application Publication
(10) Pub. No.: US 2026/0095467 A1
(43) Pub. Date: Apr. 2, 2026

(54) METHODS, IN PARTICULAR COMPUTER IMPLEMENTED METHODS, AND DEVICES FOR DETECTING AN INTRUSION IN A COMMUNICATION ON A SHARED MEDIUM

(71) Applicant: Robert Bosch GmbH, Stuttgart (DE)

(72) Inventors: Arthur Mutter, Neuhausen (DE); Friedrich Wiemer, Burgstetten (DE); Ramona Jung, Stuttgart (DE); Thomas Enderle, Muenchen (DE)

(21) Appl. No.: 19/336,790

(22) Filed: Sep. 23, 2025

(30) Foreign Application Priority Data
Sep. 30, 2024 (DE) 10 2024 209 507.9

(51) Int. Cl. H04L 9/40; H04L 67/104

(52) U.S. Cl. CPC H04L 63/1416; H04L 67/104

(57) ABSTRACT

Computer implemented methods and devices for detecting an intrusion in a communication on a shared medium, in particular a bus. A first method includes receiving a message including a first freshness value, receiving a message including a second freshness value, wherein the first freshness value and the second freshness value are correct expected freshness values, receiving a message including a warning that the message including the second freshness value is a replay message comprising a freshness value sent earlier on the shared medium, and detecting the intrusion upon receipt of the warning.

### CROSS REFERENCE

The present application claims the benefit under 35 U.S.C. § 119 of German Patent Application No. DE 10 2024 209 507.9 filed on Sep. 30, 2024, which is expressly incorporated herein by reference in its entirety.

### FIELD

The present invention relates to methods, in particular computer implemented methods, and devices for detecting an intrusion in a communication on a shared medium.

### BACKGROUND INFORMATION

Communication technologies either built point-to-point (P2P) connections or connect via a bus system, on which each participant can at any time write messages. Methods to detect and prevent colliding access on the bus are implemented to avoid problems on the bus.

On bus systems such as CAN classic, CAN FD or CAN XL typically “content based addressing” is used. This means that the address used in the transmitted frame is linked to the content of the frame. As example a frame contains the speed of a vehicle and uses as address a frame identifier value of 0x50. Now all receivers that are interested in speed will store and process a received CAN frame with frame identifier 0x50.

In the absence of node addressing, spoofing messages is possible. A malicious bus participant can send messages that other communication peers expect to be sent by another node—without the communication peers to be able to identify this.

Security protocols such as CANsec for CAN XL can prevent an unauthenticated peer to send arbitrary messages and enable checking the authenticity by the other communication peers. For this, the CANsec configuration partitions the bus participants into so called Connectivity Associations. CANsec does also, in general, enable replay protection, i.e. communication peers can check, if a message is freshly generated or was already send on the bus. This replay protection is based on including a message counter in the CANsec frame format, which is increased for every new message.

In case a node of a bus with more than two nodes communicating on the bus proceeds to a sleep mode without communication and proceeds to a wake state with communication again after a while, the situation might arise that this node missed some messages on the bus. This would result in a gap between the next message's freshness value expected by the waking up node and the actual next message's freshness value.

### SUMMARY

Computer implemented methods having certain features of the present invention mitigate adverse effects of a gap between the next message's freshness value expected by a node of a communications bus and the actual next message's freshness value. A first method detects the intrusion based on the warning. A second method is complementary to the first method and detects the intrusion based on the freshness values and sends the warning.

According to an example embodiment of the present invention, the first method, in particular computer implemented method, for detecting an intrusion in a communication on a shared medium, in particular a bus, comprises receiving a message comprising a first freshness value, receiving a message comprising a second freshness value, wherein the first freshness value and the second freshness value are correct expected freshness values, receiving a message comprising a warning that the message comprising the second freshness value is a replay message comprising a freshness value sent earlier on the shared medium, and detecting the intrusion upon receipt of the warning. This enables the detection of replay messages.

According to an example embodiment of the present invention, the method may comprise receiving the message comprising the second freshness value in a transceiver, and destroying the message comprising the second freshness value in the transceiver, in particular without forwarding the message comprising the second freshness value with the transceiver upon, detecting the intrusion. This avoids further propagation of the replay message.

According to an example embodiment of the present invention, the method may comprise receiving the warning in different messages, determining an amount of the messages comprising the warning, and detecting the intrusion upon receipt of detecting that the amount exceeds a threshold. This mitigates an overreaction based on a single warning.

According to an example embodiment of the present invention, the method may comprise receiving the message comprising the warning encrypted, and decrypting the message to receive the warning. This avoids manipulation of the warning.

According to an example embodiment of the present invention, the second method, in particular computer implemented method, for detecting an intrusion in a communication on a shared medium, in particular a bus, comprises receiving a message comprising a first freshness value, receiving a message comprising a second freshness value, wherein the first freshness value and the second freshness value are correct expected freshness values, detecting the intrusion upon detecting based on the second freshness value that the message comprising the second freshness value is a replay message comprising a freshness value sent earlier on the shared medium, and sending a message comprising a warning that the message is a replay message comprising a freshness value sent earlier on the shared medium.

According to an example embodiment of the present invention, the method may comprise receiving the message comprising the second freshness value in a transceiver, and destroying the message comprising the second freshness in the transceiver, in particular without forwarding the message comprising the second freshness with the transceiver upon, detecting the intrusion. This avoids further propagation of the replay message.

According to an example embodiment of the present invention, the method may comprise sending the message comprising the warning encrypted. The encryption protects the warning against manipulation.

According to the present invention, a device is provided for detecting an intrusion in a communication on a shared medium, the device being configured for executing the steps of the method of the present invention.

According to the present invention, a computer program is provided, the computer program comprises computer readable instructions that, when executed by the computer cause the computer to execute the method of the present invention.

Further advantageous examples are derived from the following description and the figures.

### BRIEF DESCRIPTION OF THE DRAWINGS

FIG. 1 schematically depicts a devices for communication on a shared medium, according to an example embodiment of the present invention.

FIG. 2 depicts a sequence diagram of an exemplary communication on the shared medium, according to the present invention.

FIG. 3 schematically depicts an authentication sequence without a swarm reaction, according to an example embodiment of the present invention.

FIG. 4 schematically depicts an authentication sequence with a swarm reaction, according to an example embodiment of the present invention.

### DETAILED DESCRIPTION OF EXAMPLE EMBODIMENTS

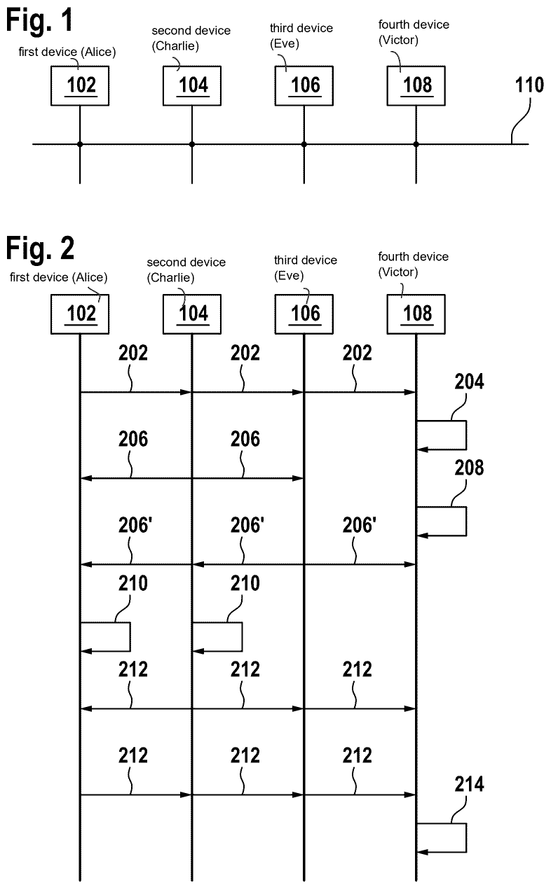

FIG. 1 schematically depicts a devices for communication on a shared medium 110.

The shared medium 110 is for example a bus systems, e.g. CAN classic, CAN FD or CAN XL. The communication on the shared medium is for example protected by a security protocol, e.g., CANsec for CAN XL.

The devices are referred to as swarm.

In the example, the swarm comprises a first device 102, Alice, a second device 104, Charlie, a third device 106, Eve, and a fourth device 108, Victor.

FIG. 2 depicts a sequence diagram of an exemplary method for detecting an intrusion in a communication on the shared medium 110.

According to the exemplary communication, Alice 102 sends a first message 202 comprising a first freshness value on the shared medium 110.

The first message 206 is received by Charlie 104 and Eve 106 and Victor 108.

Afterwards, Victor 108 proceeds to a sleep mode in a step 204. Victor 108 is unable to receive messages in the sleep mode.

Afterwards, Charlie 104 sends a second message 206 comprising a second freshness value on the shared medium 110.

The second message 206 is received by Alice 102 and Eve 106 but not by Victor 108.

Afterwards, Victor 108 proceeds to a wake-up mode in a step 208. Victor 108 is able to receive messages in the wake-up mode.

Afterwards, Eve 106 sends a third message 206′ comprising the second freshness value on the shared medium 110.

The third message 206′ is received by Alice 102, Charlie 104, and Victor 108.

Upon receipt of the third message 206′, Alice 102 and Charlie 104 detect based on the second freshness value the intrusion, in particular that the third message 206′ is a replay message having the same freshness value as the earlier received second message 206.

Upon detecting the intrusion, Alice 102 and Charlie 104 send a respective fourth message 212 comprising a warning that the third message 206′ is a replay message comprising a freshness value sent earlier on the shared medium.

The fourth messages 212 are received by Eve 106 and Victor 108. Charlie 104 receives the fourth message 212 sent by Alice 102. Alice 102 receives the fourth message 212 sent by Charlie 104.

Afterwards, Victor 108 determines in a step 212 an amount of the fourth messages received by Victor 108.

Afterwards, Victor 108 detects in a step 214 the intrusion upon detecting that the amount exceeds a threshold.

Determining the amount and detecting the intrusion based on the amount and the threshold are optional. The intrusion may be detected upon receipt of one fourth message 212, in particular without determining the amount or comparing the amount to the threshold.

The method for detecting the intrusion is not limited to detecting the intrusion depending on the fourth messages 212 received from Alice 102 and/or Charlie 104. The swarm may comprise more or less devices. Victor 108 may receive the warning in different fourth messages 212 from any device of the swarm and determine the amount of the fourth messages 212, and detect the intrusion upon receipt of detecting that the amount exceeds a threshold.

The method may comprise sending and receiving the respective fourth message 212 encrypted, and decrypting the respective fourth message 212 to receive the warning.

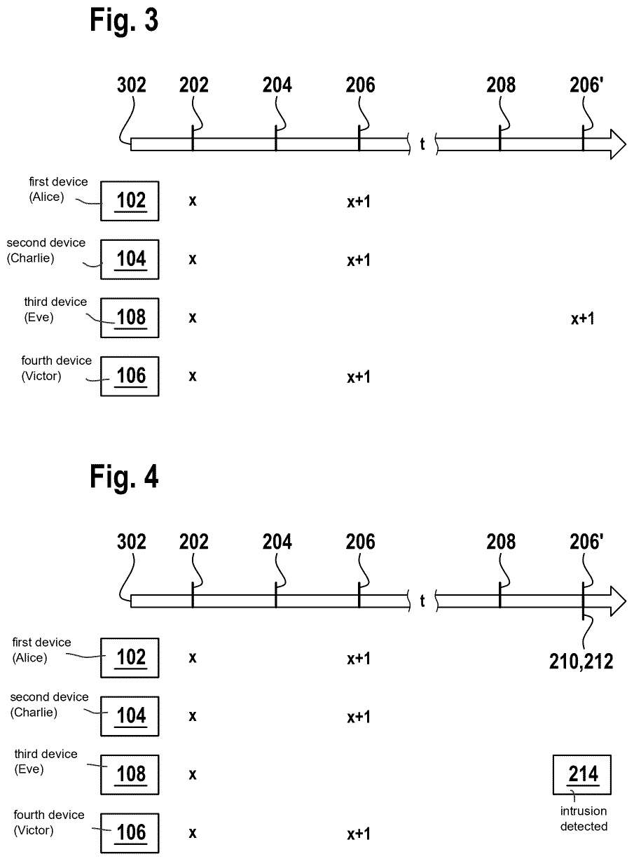

FIG. 3 schematically depicts an authentication sequence over time t without a swarm reaction of the swarm.

After a start 302 of the communication, Alice sends the first message 202 with the first freshness value x. Alice 102, Charlie 104, Eve 106, and Victor 108 expect the first freshness value x.

After Victor 108 proceeds to the sleep mode in step 204, Charlie 104 sends the second message 206. Alice 102, Charlie 104, and Eve 106 expect the second freshness value x+1.

After Victor 108 proceeds to the wake-up mode in step 208, Eve 106 sends the third message 206′ with the second freshness value x+1. Alice 102, Charlie 104, and Eve 106 expect the freshness value x+2. Victor 108 expects the freshness value x+1.

Without the swarm reaction of the swarm, Alice 102 and Charlie 104 detect the replay message and may not authenticate the third message 206′.

Without the swarm reaction of the swarm, Victor 108 is unable to detect the replay message and may authenticate the third message 206′.

FIG. 4 schematically depicts an authentication sequence over time t with a swarm reaction of the swarm.

The authentication sequence with the swarm reaction is the same as the authentication sequence without the swarm reaction until the third message 206′ is received by Alice 102 and Charlie 104. Alice 102 and Charlie 104 expect the freshness value x+2 due to the receipt of the second message 206 with the second freshness value x+1 but detect the that the third message 206′ comprises the freshness value x+1.

Alice 102 and Charlie 104 send the fourth message 212 and Victor 108 detects in the step 214 the intrusion upon receipt of the warning in the fourth message 212.

With the swarm reaction of the swarm, Alice 102 and Charlie 104 detect the replay message and may not authenticate the third message 206′. With the swarm reaction Victor is able to detect the replay message as well and may not authenticate the third message 206′.

The freshness value in the example is incremented by 1 because there is no message sent between the first message and the second message. The method is not limited to successive freshness values. The increment may be as large, as Victor 108 missed messages.

The messages may be received in a transceiver of the respective device.

Reactions of the respective device to detecting the intrusion may be destroying the third message 206′ in the transceiver, in particular without forwarding the third message 206′.

What is claimed is:

1. A computer implemented method for detecting an intrusion in a communication on a shared medium including a bus, the method comprising the following steps:
receiving a message including a first freshness value;
receiving a message including a second freshness value, wherein the first freshness value and the second freshness value are correct expected freshness values;
receiving a message including a warning that the message including the second freshness value is a replay message including a freshness value sent earlier on the shared medium; and
detecting the intrusion upon receipt of the warning.

2. The method according to claim 1, further comprising:
receiving the message including the second freshness value in a transceiver; and
destroying the message including the second freshness value in the transceiver, without forwarding the message including the second freshness value with the transceiver, upon detecting the intrusion.

3. The method according to claim 1, further comprising:
receiving the warning in different messages;
determining an amount of the messages including the warning; and
detecting the intrusion upon receipt of detecting that the amount exceeds a threshold.

4. The method according to claim 1, further comprising:
receiving the message including the warning encrypted; and
decrypting the message to receive the warning.

5. A computer implemented method for detecting an intrusion in a communication on a shared medium including a bus, the method comprising the following steps:
receiving a message including a first freshness value;
receiving a message including a second freshness value, wherein the first freshness value and the second freshness value are correct expected freshness values;
detecting the intrusion upon detecting based on the second freshness value that the message including the second freshness value is a replay message including a freshness value sent earlier on the shared medium; and
sending a message including a warning that the message including the second freshness value is a replay message including a freshness value sent earlier on the shared medium.

6. The method according to claim 5, further comprising:
receiving the message including the second freshness value in a transceiver; and
destroying the message including the second freshness in the transceiver, without forwarding the message including the second freshness with the transceiver, upon detecting the intrusion.

7. The method according to claim 5, further comprising:
sending the message included the warning encrypted.

8. A device for detecting an intrusion in a communication on a shared medium including a device is configured to detect an intrusion in a communication on a shared medium including a bus, the device being configured to:
receive a message including a first freshness value;
receive a message including a second freshness value, wherein the first freshness value and the second freshness value are correct expected freshness values;
receive a message including a warning that the message including the second freshness value is a replay message including a freshness value sent earlier on the shared medium; and
detect the intrusion upon receipt of the warning.

9. A non-transitory computer-readable medium on which is stored a computer program including computer readable instructions for detecting an intrusion in a communication on a shared medium including a bus, the instructions, when executed by a computer, causing the computer to perform the following steps:
receiving a message including a first freshness value;
receiving a message including a second freshness value, wherein the first freshness value and the second freshness value are correct expected freshness values;
receiving a message including a warning that the message including the second freshness value is a replay message including a freshness value sent earlier on the shared medium; and
detecting the intrusion upon receipt of the warning.
